(19) United States
(12) Patent Application Publication
(10) Pub. No.: US 2015/0022030 A1
(43) Pub. Date: Jan. 22, 2015

(54) LINEAR MOTOR

(71) Applicant: NTI AG, Spreitenbach (CH)

(72) Inventors: Ronald Rohner, Widen (CH); Ernst Blumer, Zuerich (CH); Sandro Ludolini, Niederbipp (CH)

(21) Appl. No.: 14/331,482

(22) Filed: Jul. 15, 2014

(30) Foreign Application Priority Data
Jul. 19, 2013 (EP) 13177248.5

(51) Int. Cl. H02K 11/00; H02K 41/02

(52) U.S. Cl. CPC H02K 11/0021; H02K 41/02; H02K 11/0015; H02K 11/0026
USPC 310/12.19

(57) ABSTRACT

A linear motor comprises a stator (1) which has a longitudinal axis (16), and an armature (2) which is movable relative to the stator (1) between two end positions in the direction of the longitudinal axis (16). Either the stator (1) or the armature (2) has energizable electric coils (12) and the armature (2) or the stator (1) is excited by a permanent magnetic field which is periodic in the direction of the longitudinal axis (16). The linear motor further comprises a position detection system (100; 200; 300; 400; 500) for detecting the position of the armature (2) relative to the stator (1). The position detection system (100; 200; 300; 400; 500) is a contactless operating position detection system which is adapted to generate a signal that corresponds to the distance between a reference location (11a; 15a) on the stator (1) and a reference location (24a) on the armature (2).

The present invention relates to a linear motor in accordance with the preamble of the independent claim.

Linear motors are used in a variety of applications in the automation technology, in packaging machines, in tooling machines as well as in other fields. In the following, linear motors are referred to as electric direct drives that function according to one of the well-known electromagnetic principles.

A liner motor comprises a stator and an armature that is movable relative to the stator in the direction of the stator's longitudinal axis (in the following referred to as “in longitudinal direction”). The force for the drive of the armature is typically generated by a permanent magnetic excitation on one of the two components, stator or armature while the respective other component is provided with electrifiable coils to which current is supplied. Mostly, the permanent magnetic excitation is generated by discrete permanent magnets which are arranged such that a periodic magnet field with alternating North- and South Poles is generated in longitudinal direction. Whether the permanent magnets are located in the stator or in the armature and correspondingly the coils are located in the armature or in the stator often depends on the desired field of application or the local conditions.

For example, the permanent magnets can be arranged in a pipe-like armature wherein the pipe is made of a nonmagnetic material (e.g. aluminum or chrome steel). The magnetization has a pattern of, for example, N-S-N-S-N . . . (N=magnetic North Pole, S=magnetic South Pole) when viewed in longitudinal direction and therefore, it is periodic. Such a magnetization can typically be generated by assembling permanent magnetic disks, if desired with intermediately arranged iron disks and/or nonmagnetic spacers. In principle, it is also possible to use a long magnetic stick, which is already magnetized in the desired way, instead of discrete permanent magnetic disks. For example, a typical linear motor of this type is described in EP 2 169 356 and U.S. Pat. No. 6,316,848.

Such linear motors are also referred to as tubular linear motors. One of the big advantages of such tubular linear motors is that they essentially comprise only two components the stator and the armature. Additional components such as gears, spindles, belts or mechanical levers can be omitted. Therefore, the user, i.e. the machine constructor, doesn't have to take care of the alignment of axles, band pulleys or other mechanical parts but can directly and purposefully use the linear motor where a linear movement is needed. It is characteristic for tubular linear motors that these motors are constructed very compact, and that they have a tubular shape. In most cases, the bearing of the armature is already integrated in the linear motor, or its stator respectively. This is particularly advantageous when the spatial conditions within a device in which the linear motor is to be used are generally very narrow and the accessibility for installation—and alignment works are also restricted.

Other constructional forms of linear direct motors are mostly less compact and are provided with dedicated bearings in the form of circulating ball bearings which run on profiled rail guiding systems. Such bearings are significantly more accurate and also more load bearing than simple sliding bearings which are mostly used in tubular linear motors. For all constructional forms of linear motors one is principally free in embodying either the motor part having the coil windings or the permanent magnetically excited part of the motor to be movable. For flat linear motors, it is mostly the coil part that is movable, whereas in tubular linear motors it is usually the permanent magnetic part of the motor which is movable. One of the reasons can again be found in the thus obtained simplicity of the concept: While there is a trailing chain system necessary for supplying the movable winding part with phase current, this complex and additional space needing construction can be left omitted for a fixedly arranged winding part. This shows once again that for tubular linear motors the compact and simple construction prevails.

One of the performance features of a linear motor is the accurate position control of the armature, wherein this position control is based on an exact detection of the position of the armature relative to the stator.

For the purpose of the position detection in flat linear motors, mostly a positioning sensor (externally visible) is attached to the movable part of the windings (armature). Parallel to the profiled rails for the guidance of the movable winding part, a related information carrier (sensor band) is mounted for the position detection. This information carrier consists of a band having optical, magnetic or inductive information, depending on the desired principle. In relation to the profiled rails, the width of the sensor band is small and is of minor importance from a constructional point of view. For the supply of the connection cables to the position sensor or the sensor head on the movable winding part, the same trailing chain system can be used as is used for the supply of the motor phase cables.

However, in tubular linear motors the position detection is optimized with a view on the compact and cost-effective construction of these drive elements. Accordingly, the permanent magnets arranged inside of the armature are used not only for driving but also as information carrier for the position detection. For this purpose, for example, two magnetic field sensors, typically Hall sensors, are arranged in the stator of the linear motor and are offset relative to each other in longitudinal direction by a predetermined distance. The mutual distance of these two Hall sensors is preferably one quarter of the length of a magnetic period. In order to assure this distance, the sensors are inserted in a mount and built into the stator as is described for example in the document U.S. Pat. No. 6,316,848. Both Hall sensors measure the magnetic field which is periodic in longitudinal direction (magnetic field strength) and generate two identical signal which are phase shifted by 90° for a linear shift of the armature relative to the stator (and therefore also to both Hall sensors). Assuming a sinusoidal field, one of the Hall sensors detects a signal of the type A(φ)=A·sin(φ) and the other Hall sensor detects a signal B of the type B(φ)=B·sin)(φ−90°)=B·cos(φ), wherein the amplitudes A and B are of equal height. The process of the sine-cosine-evaluation of the two signals offset by 90° known for example from the documents EP 2 169 356 and U.S. Pat. No. 6,316,848 enables the exact position detection within a quadrant. This calculation is performed using the formula: φ:=arc tan(A(φ)/B(φ)). An additional evaluation of the signal (signs of the signals) of both Hall sensors gives the quadrant as well as the direction of the movement of the armature. Counting the periods of the magnetic field in combination with the position within the corresponding period of the magnetic field results in the exact absolute position of the armature (relative to the stator) in any area of the displacement path. For this kind of position detection it is particularly advantageous that the permanent magnets which are anyway present for driving can be used as information carrier. In addition, the Hall sensors are constructionally easy to integrate in the stator and any external contructions or parts can be omitted.

The described process of the sine-cosine evaluation and of the counting of the periods of the magnetic field is also used in the same form for the already described external sensor systems consisting of a sensor head (position sensor) and a sensor band. Another thing in common is the situation that the position—given the technical restrictions—can be detected exactly and for any range but this represents only a relative reference value. “Relative” in this context means that the sensor system recognizes when being switching on, where it is located within a period of the periodic magnetic field but it doesn't know which period it is. In other words, after each switching on process there must be a reference run of the armature. This is also knows as initialization. In a tubular linear motor, the armature is driven in longitudinal direction until it either abuts against against a mechanical stop at a predetermined position, or until it acts on a mechanical or contactless switch arranged at this predetermined position. Thereafter, an absolute position detection can be performed from this predetermined position (relative to the stator) by counting the number of them passed individual periods of the magnetic field. The same processes can be used for flat linear motors as well. In addition, certain sensor head/sensor band-systems also offer the option that on a separate trail on the sensor band an initial position is applied which can be detected during the initialization run. As already mentioned, this initialization—or reference run must be performed during each switching on of the motor. Alternatives in the sense of saving the last position in a permanent storage fail because linear motors can be freely moved in a non-energized state and, therefore, the position of the armature relative to the stator can be changed in the non-energized state. Battery buffered sensors for which the position detection is continued in turned off mode are mostly unsuitable for industrial applications.

In the application of linear motors which must perform a reference run, this point be particularly considered during the construction of the machine which the linear motor is made for. This is so because the armature of these motors must be movable from any arbitrary position in the direction of the initialization position. Especially for complex applications where multiple linear motors perform interlocking movements this is not easy to realize and often leads to technical restrictions. For this reason, one would like to abstain from a reference run or the use of absolute position measuring systems is called for. There are several variants of such systems available on the market.

The most common variant consists of a sensor head (position sensor) and a sensor band. Additional information traces are applied to the sensor band which also include in a suitable coding the absolute position of the sensor head relative to the beginning of the belt. Specific electronics in the sensor head evaluate the coded path information and converts them into a standardized interface form (e.g. SSI) which can then be evaluated. Other variants aim at, for example, a specific magnetorestrictive measuring axle which is mounted parallel to the motor. Along this magnetorestrictive measuring axle a positioning magnet is moved by the linear motor. Once an electrical current impulse is sent through the measuring axle, the magnetic field of this electrical current impulse together with the magnetic field of the position magnet generate a mechanical oscillation in the measuring axle thorough the magnetorestrictive effect. The duration of the run time of the oscillation to the end of the axle can now be measured and be used for the absolute position evaluation. Additional principles make use of, for example, ultrasound emitters or potentiometer switches in the evaluation of the absolute position, wherein the latter are often realized in the form of a measuring cylinder. All principles have in common that additional components have to be mounted parallel to the linear motor. In flat linear motors, this is not a real problem since guide rails or a magnetic band are present anyway. However, if a tubular linear motor is equipped with an absolute magnetic band sensor or a parallel guided measuring cylinder this leads to major restrictions in applications in addition to the high costs for such sensor systems. The compact and integrated constructional form of the tubular linear motor is to a large extend impaired by such an external absolute position detection.

It is an object of the invention to improve a linear motor of this type with respect to the position detection of the armature such that on one hand, an absolute position detection of the armature (relative to the stator) is possible without initialization or a reference run of the armature and that on the other hand, the measuring means required for the position detection are inexpensive and do not increase the constructional volume of the linear motor or increase the constructional volume of the linear motor only insubstantially,so that in total, a compact and integrated constructional form of the linear motor is achieved or maintained while restrictions in applications can be avoided.

This object is achieved by the linear motor according to the invention as it is defined by the features of the independent claim. Preferred embodiments of the linear motor according to the invention are evident from the features of the dependent claim.

The linear motor according to the invention comprising a stator which has a longitudinal axis, and an armature which is movable relative to the stator between two end positions in the direction of the longitudinal axis, wherein either the stator or the armature has energizable electric coils and the armature or the stator is excited by a permanent magnetic field which is periodic in the direction of the longitudinal axis. The linear motor further comprises a position detection system for detecting the position of the armature relative to the stator. The position detection system is a contactless operating position detection system which is adapted to generate a signal that corresponds to the distance between a reference location on the stator and a reference location on the armature. Due to the contactless distance measurement between the stator and the armature the constructional expands and the constructional volume can be kept small. An evaluation electronics for evaluating these signals can in general be part of the linear motor but it can also be part of an external electronics. The same applies for the driving electronics (energization of the coils) which can either be part of the linear motor, too, but which is often part of an external electronics. In any case, the absolute position of the armature relative to the stator can be detected form the signals with the aid of the evaluation electronics (whether part of the linear motor or not).

In accordance with a preferred embodiment the stator has the coils and the armature is excited by the permanent magnetic field which is periodic in the direction of the longitudinal axis. The position detection system has internal magnetic field sensors arranged within the stator and external magnetic field sensors arranged external to the stator in a fixed spatial relation to the stator. The internal and external magnetic field sensors are adapted for the detection of the permanent magnetic field of the armature at the location of the respective magnetic field sensor and for the generation of signals which correspond to the respective detected permanent magnetic field. The internal and external magnetic field sensors are connected to the evaluation electronics (regardless of whether it is part of the linear motor itself or not). The evaluation electronics is adapted to detect the absolute position of the armature relative to the stator from the signals generated by the internal and external magnetic field sensors. This absolute position detection with the aid of internal and external magnetic field sensors is particularly easy to realize and practically needs no additional constructional volume.

In accordance with a further advantageous aspect the internal magnetic field sensors are arranged offset relative to each other in the direction of the longitudinal axis by one quarter of the length of the period of the armature's periodic permanent magnetic field in a manner such that they are impinged in any position of the armature by the periodic permanent magnetic field thereof. Accordingly, the evaluation electronics (whether part of the linear motor itself or not) is adapted to evaluate the measuring signals generated by the internal magnetic field sensors to detect the position of the armature within a period of the periodic permanent magnetic field.

In accordance with a further advantageous aspect the external magnetic field sensors are arranged in the direction of the longitudinal axis along the displacement path of the armature in a manner such that depending on the position of the armature a varying number of the external magnetic field sensors are impinged by the periodic magnetic field of the armature. Accordingly, the evaluation electronics (whether part of the linear motor itself or not) is adapted to evaluate the measuring signals generated by the external magnetic field sensors for the detection of that period of the periodic permanent magnetic field of the armature which impinges on the internal magnetic field sensors.

Advantageously, the distance between two adjacently and offset to each other arranged external magnetic field sensors is half the length of a period of the periodic permanent magnetic field of the armature.

In accordance with a further advantageous aspect the external magnetic field sensors are adapted to detect both the strength as well as the polarity of the armature's magnetic field. The distance between two adjacently and offset to each other arranged external magnetic field sensors is a full length of a period of the periodic permanent magnetic field of the armature. Thereby, the number of the necessary external magnetic field sensors is reduced to half the number.

It is advantageous if the external magnetic field sensor which is farthest from the stator is arranged such that it detects the end magnetic field of the armature. By this measure it is prevented that all magnetic field sensors simultaneously measure no magnetic field when the armature is in a critical position which would render a position detection impossible. The external magnetic field sensor farthest from the stator is capable of measuring the end magnetic field even when the armature is in a critical position one period before its end position. In this case, the signal of the external magnetic field sensor farthest from the stator is then weaker than compared to a signal when the armature is in a critical position immediately before its end position. For this purpose, the external magnetic field sensor farthest from the stator must be capable of converting the value (amplitude) of the end magnetic field impinging thereon into a corresponding signal. In accordance with a further advantageous aspect the position detection system comprises two rows of external magnetic field sensors, wherein the external magnetic field sensors of one row are arranged offset in longitudinal direction relative to the external magnetic field sensors of the other row by a predetermined distance. Accordingly, for the detection of the position of the armature the evaluation electronics (whether part of the linear motor itself or not) is adapted to evaluate the signals of the magnetic field sensors of that row whose magnetic field sensors (absolutely) detect higher field strengths of the periodic permanent magnetic field of the armature. Principally, it is possible that the armature is in a position in which one row of magnetic field sensors is arranged such that it coincides with the zero values of the magnetic field so that the magnetic field sensors of this row generate no signal which allow for an evaluation.

Preferably the predetermined distance between the two rows is at least one eighth, preferably one quarter, of the period of the periodic permanent magnetic field of the armature. By this measure, too, it is prevented that all magnetic field sensors simultaneously measure no magnetic field or generate no signal when the armature is in a critical position which would render a position detection impossible.

As already mentioned above, the linear motor according to the invention is preferably embodied as a tubular linear motor. The armature is bar-shaped and extends through the stator. The armature is movably arranged within the stator relative thereto in the direction of the longitudinal axis.

In accordance with a further aspect of such tubular linear motor the stator has a tubular extension on one end which encloses the armature. The tubular shaped extension serves for the mounting of the external magnetic field sensors (in this tubular extension) and for the protection of the external magnetic field sensors. Accordingly, in an embodiment of the linear motor according to the invention, the external magnetic field sensors are arranged inside the tubular extension.

In accordance with a further advantageous aspect, the position detection system is embodied as a contactless operating distance measuring system which is arranged on the stator coaxial to the armature, and which is capable of generating a signal that corresponds to the distance from an end of the armature moved out of the stator to the corresponding end of the stator from which the armature is moved out. The distance measuring system can be based on, for example, laser technology, radar technology or acoustic technology.

In accordance with further aspect, the position detection system is embodied as a laser distance measuring system which includes a laser light source arranged on the stator and a laser light receiver also arranged on the stator, as well as a laser light reflector arranged on one end of the armature.

The radial distance of the laser distance measuring system from the longitudinal axis is in the range of 4 mm to 40 mm. For such a small radial distance of the laser distance measuring system from the longitudinal axis, the constructional size of the linear motor in total can be maintained since the radius of the stator is larger than that of the armature in the same order of magnitude.

Additional advantageous aspects are evident from the following description of embodiments of the linear motor with the aid of the drawing, in which:

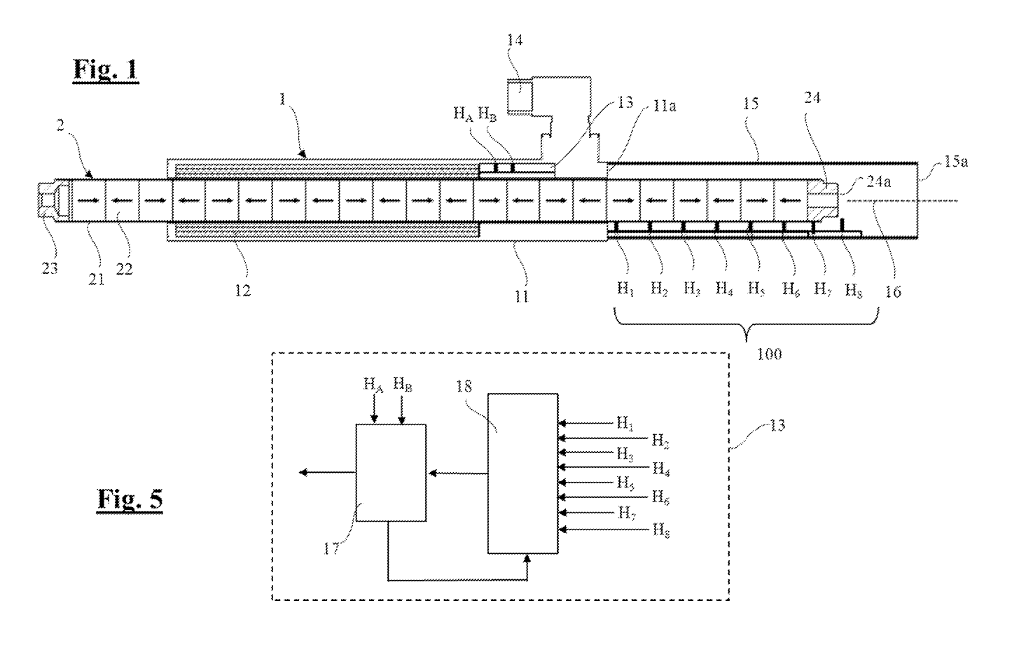

FIG. 1 shows a simplified longitudinal section through a first embodiment of the linear motor according to the invention;

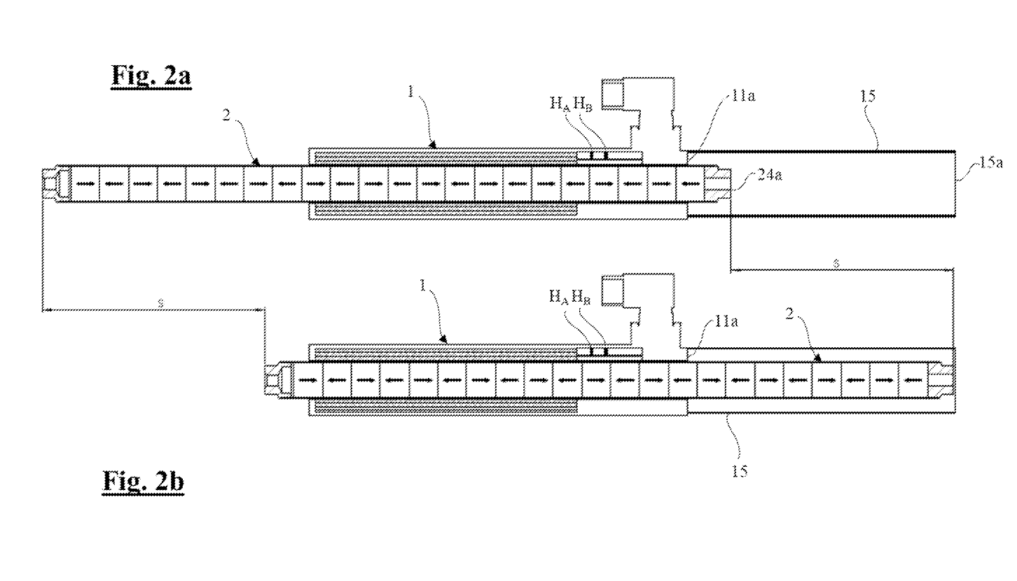

FIG. 2a, 2b show the linear motor from FIG. 1 with two end positions of its armature;

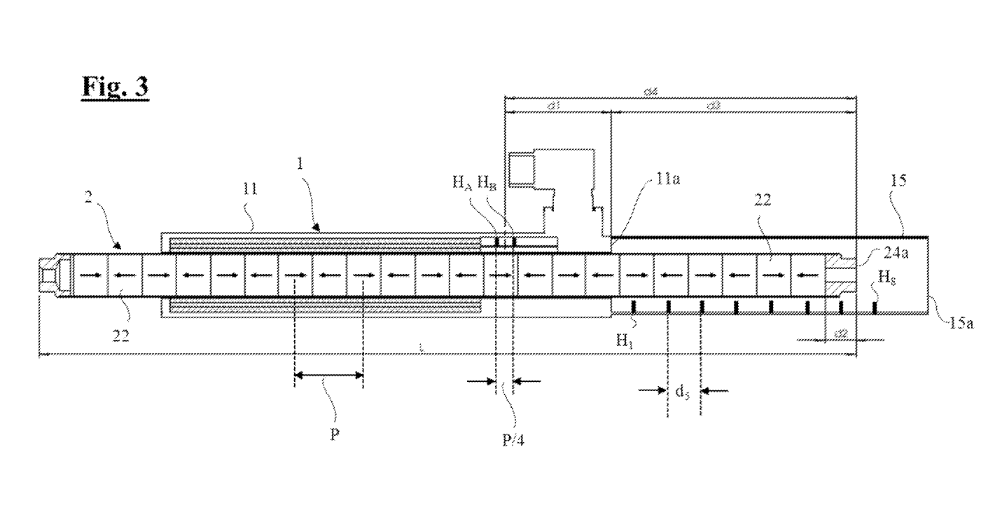

FIG. 3 shows a longitudinal section analog to FIG. 1 with distance indicators;

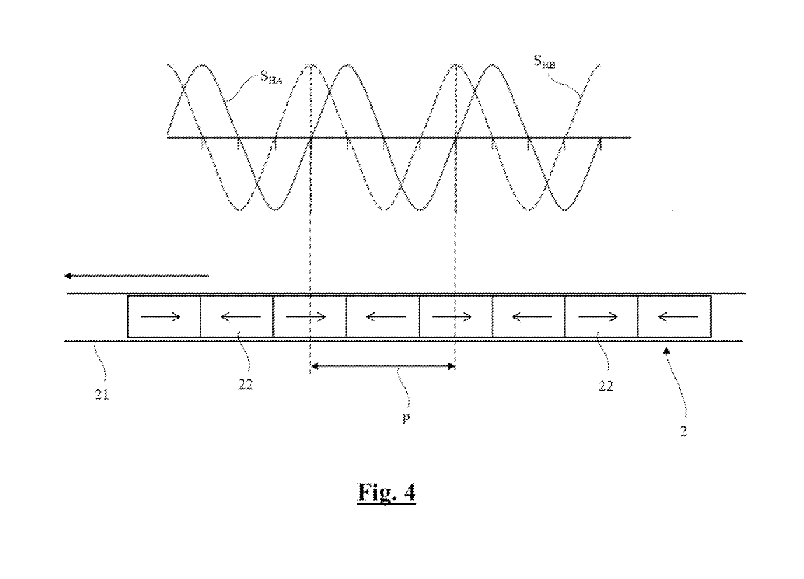

FIG. 4 shows a typical course of the permanent magnetic field along a portion of the armature and the corresponding signals of the internal magnetic field sensors;

FIG. 5 shows a block diagram of an electronics for the detection of the position of the armature;

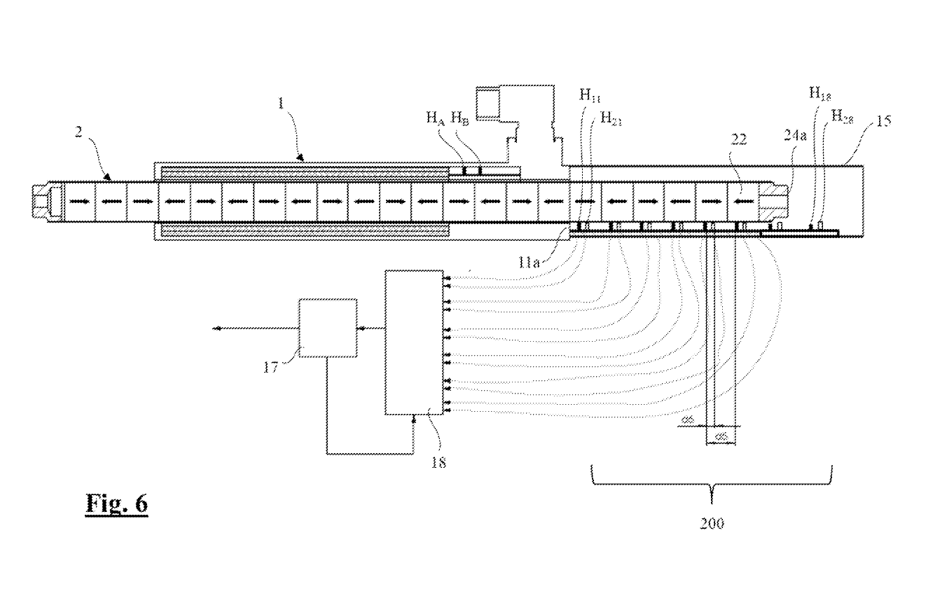

FIG. 6 shows a longitudinal section through a second embodiment of the linear motor according to the invention;

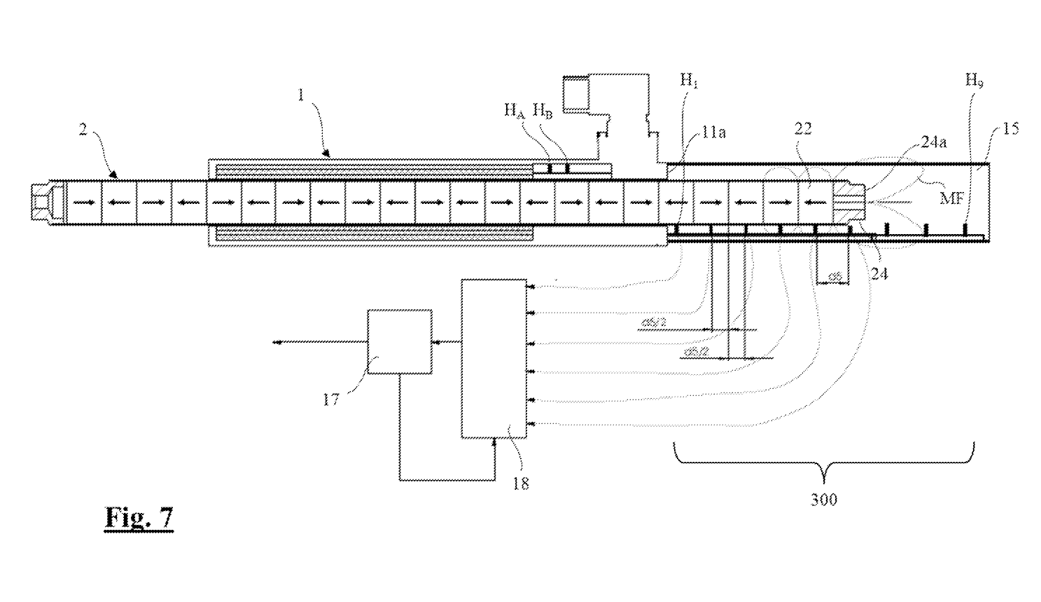

FIG. 7 shows a longitudinal section through a third embodiment of the linear motor according to the invention;

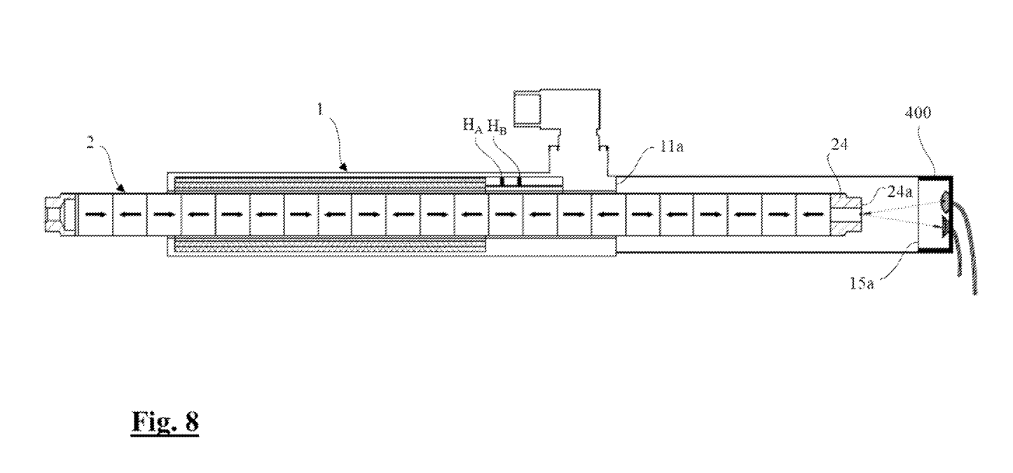

FIG. 8 shows a longitudinal section through a fourth embodiment of the linear motor according to the invention and

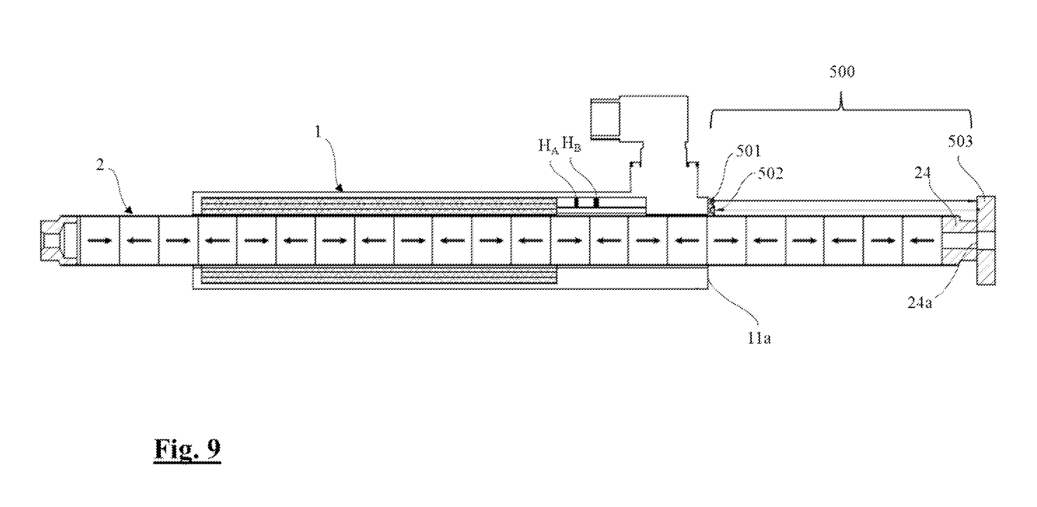

FIG. 9 shows a longitudinal section through a fifth embodiment of the linear motor according to the invention.

For the subsequent description the following definition applies: If reference signs are indicated in a figure for the purpose of clarity of the drawings which not mentioned in the directly corresponding part of the description it is referred to the explanation in the proceeding or subsequent parts of the description. Vice versa, for the avoidance of overloading of the drawings less relevant reference signs which are less relevant for the direct understanding are not indicated in all figures. It is referred to the remaining figures.

The first embodiment of the linear motor according to the invention, illustrated in FIG. 1 is embodied as a tubular linear motor having a permanently excited armature and comprises a stator 1 and an armature 2 which is longer than the stator 1 and which, depending on its position, extends more or less out of the stator 1.

The stator 1 comprises a stator housing 11 in which electrical coils 12 and a electronics 13 are arranged. The electronics 13 serves for the evaluation of signals and for the communication with an external motor control (not shown) and also comprises several protective circuits as well as the evaluation electronics 17, discussed further below, for the calculation of the position of the armature based on measuring signals of position sensors supplied to the evaluation electronics. Alternatively, the electronics 13 may be embodied such that it serves only as communication interface to an external motor control and therefore only transmits the signals of the magnetic field sensors arranged in the motor to the external motor control but doesn't evaluate them itself. A plug 14 on the stator housing 11 serves for the connection of electrical connecting cables. At its rear end 11a (in FIG. 1 at the right end) the stator 1 has a tubular extension 15 which encloses the armature and serves for housing and mounting (arrangement) and for the protection of components of a position detection system described further below.

The armature 2 comprises a chrome steel pipe 21 which is glidingly mounted in the stator housing 11 in the direction of its longitudinal axis 16 thereof (in the following described as “in longitudinal direction”). In the interior of the pipe 21a number of (in this example twenty-two) permanent magnetic disks 22 are arranged, which are mutually reversely oriented, so that in total they generate a periodic permanent magnetic field along the length of the armature 2. Between the individual magnets 22 additional iron disks or spacers can be inserted. It is only essential that the magnets 22 generate a periodic magnetic field along the length of the armature. Both ends of the chrome steel pipe 21 are closed by terminal pieces 23 and 24 for the protection of the permanent magnetic disks 22 arranged in the chrome steel pipe 21.

By a suitable energization of the coils 12 the armature 2 can be moved in the direction of its longitudinal axis 16 in one or the other direction (in FIG. 1 to the left or to the right) in a manner known per se. FIG. 2a and FIG. 2b respectively show the linear motor with a fully extended armature (FIG. 2a) or with a fully retracted armature (FIG. 2b). From this the maximum displacement path s or the stroke of the armature 2. As can be seen from FIG. 2b, the tubular extension 15 of the stator 1 is exactly that long that it completely accommodates the rear portion of the armature 2 extending out of the stator when the armature is in the fully retracted state.

Through the tubular extension 15 of the stator the linear motor optically looks bigger but application-specific there is only little change compared to a linear motor without such tubular extension 15 since the space behind the stator 1 must in any event be kept free for the armature 2. Only the diameter of the space needed behind the stator 1 is slightly bigger due to this tubular extension.

Apart from the tubular extension 15 of the stator 1 linear motor according to the invention is embodied conventionally with respect to construction and manner of operation and therefore doesn't require any further explanation. The differences of the linear motor according to the invention compared to known linear motors are in the type and the manner of the position detection of the armature 2 or the means used for the position detection, as will be explained in detail in the following.

The position detection system of the armature 2 in the shown embodiment of the linear motor according to the invention is based on the measurement of the periodic permanent magnetic field of the armature 2 by means of magnetic field sensors and the evaluation of the signals generated by the magnetic field sensors. Hall sensors are preferably used as magnetic field sensors and in the following hall sensors will be referred to. It is requirement that the magnetic field sensors or the hall sensors are capable of not only detecting the strength of the magnetic field but also of its polarity (N or S). The end 11a of the housing serves as reference location of the stator 1 and the rear end 24a of the armature 2 serves as reference location of the armature 2.

The position detection system comprises several magnetic field or hall sensors which are divided into two groups. A first group of hall sensors comprises two hall sensors H_{A} and H_{B} which are arranged inside of the stator housing 11 and which are always impinged by the periodic magnetic field of the armature 2 independent of the actual position of the armature 2. These two hall sensors H_{A} and H_{B} of the first group of hall sensors are in the following referred to as internal hall sensors. A second group of hall sensors comprises a number of additional hall sensors H₁-H₈ which are arranged outside of the stator housing 11 in the tubular extension 15 in fixed spatial relationship to the stator and which detect the periodic magnetic field of the rear portion of the armature which extends more or less out of the housing 11 depending on the position of the armature 2. These hall sensors H₁-H₈ are in the following referred to as external hall sensors. The entirety of the internal and external hall sensors are part of the position detection system 100.

As can be seen from FIG. 3, both internal hall sensors H_{A} and H_{B} are arranged at a defined distance d₁ from the rear end 11a of the stator housing 11. Both internal hall sensors H_{A} and H_{B} are mutually offset by in the longitudinal direction of the stator 1 by one quarter of the magnetic period P of the permanent magnetic field of the armature 2. In case the armature 2 is moved along both internal hall sensors these two hall sensors generate the essentially sine-shaped or cosine-shaped signal S_{HA} or S_{HB} shown in FIG. 4, and consequently these two signals are phase-shifted relative to each other by a quarter of a period or 90°, respectively. The two internal hall sensors serve in a manner known per se (see, for example, EP 2 169 356 and U.S. Pat. No. 6,316,848) for the detection of the relative position of the armature 2 within one period of the magnetic field, wherein this relative position (or phase) within a quadrant of the magnetic field period can be calculated from the quotient of the signals S_{HA} and S_{HB} according to the formula x=arc tan(S_{HA}/S_{HB})·P/2π, wherein P is the length of a period of the periodic permanent magnetic field of the armature 2. From the signs of the two signals S_{HA} and S_{HB} the respective quadrant can be determined The calculation of the position is performed in a preferably micro processor-based evaluation electronics 17 to which the signals of the two internal hall sensors H_{A} and H_{B} are supplied. The evaluation electronics 17 can be constructionally integrated into the electronics 13 (FIG. 5) which may be part of the linear motor itself but which may also be embodied as an external electronics (motor control) so that the evaluation electronics 17 is then integrated in this external electronics.

The last (rearmost) permanent magnetic disk 22 has a distance d₂ from the rear mechanical end 24a of the armature 2 and the armature 2 in its entirety has a (total) length L. The distance d₁ and d₂, as well as the length L of the armature, the number of permanent magnetic disks 22, and the length of the period P of the periodic permanent magnetic field are known. For the absolute position detection system of the armature 2 (relative to the stator 1) the rear end 11a of the stator housing 11 is taken as a reference location. The reference location of the armature 2 is the rear end 24a thereof. It is the aim to determine the distance d₃ of the rear end 24a of the armature to the rear end 11a of the stator housing 11 or the distance d₄, to the two internal hall sensors H_{A} and H_{B} mounted in the stator 1. Once these distances d₃ and d₄ are determined, the absolute position of the armature 2 relative to the stator 1 is determined and a reference run can be completely dispensed with.

It is sufficient to determine in which magnetic period of the periodic permanent magnetic field of the armature the two internal hall sensors are located. The exact position within this period is determined by the internal hall sensors H_{A} and H_{B}.

In FIG. 1 and FIG. 3, by way of example there is shown an axial displacement between the armature 2 and the stator 1 wherein three periods of the periodic permanent magnetic field of the armature 2 are outside of the stator housing 11, and accordingly (in this example) the two internal hall sensors are in the fifth period of the periodic permanent magnetic field of the armature 2. Due to the known mechanical dimensions of the armature, stator, the permanent magnetic disks and the length of the period of the periodic permanent magnetic field the absolute axial position of the armature 2 relative to the stator 1 can be directly calculated. In case the internal hall sensors H_{A} and H_{B} are located in the n^{th} period of the periodic permanent magnetic field (viewed from the rear end of the armature) the distance amounts d₃=n*P−x−d₁+d₂, wherein x is the position of the internal hall sensors within the n^{th} period.

The external hall sensors H₁-H₈, arranged in the extension 15 of the stator 1 serve for the determination of the actual period of the periodic permanent magnetic field of the armature 2. By means of these external hall sensors H₁-H₈, it is determined how many periods of the periodic permanent magnetic field of the armature 2 extend out of the end 11a of the stator housing 11 (or the rear end of the stator 1). By means of the distance d₁ of the internal hall sensors H_{A}, H_{B} from the rear end 11a of the stator housing and the length of the period P it results in which period of the periodic permanent magnetic field of the armature the two internal hall sensors H_{A} and H_{B} are located.

The external hall sensors H₁-H₈ are arranged one after the other spaced by distance d₅ from each other which exactly corresponds to half the length of a period P or a pole pitch. The signals of the external hall sensors H₁-H₈ are supplied to the evaluation electronics 17 via a multiplexer 18, as this is shown in FIG. 5. By means of the multiplexer 18, the signals of the individual hall sensors H₁-H₈ can be sequentially supplied to an analog/digital-converter (A/D-Converter) included in the evaluation electronics so that the electronical expense is limited despite multiple hall sensors. Since this position detection must be performed only once after the powerup of the system, i.e. the armature 2 has not yet moved at this point in time, the evaluation of the sensor signals is not time-critical. The evaluation electronics detects which one or which ones of the external hall sensors H₁-H₈ measure a magnetic field. Based on the evaluation of the sensor signals it results how many pole pitches or magnets of the armature 2 extend out of the end 11a of the stator housing 11 or in which magnetic period the two internal hall sensors H_{A}, H_{B} in the stator are located relative the (rear) end of the armature.

The number of the external magnetic field sensors depends on the maximum number of periods or pole pitches of the periodic permanent magnetic field of the armature which may extend out of the rear end 11a of the stator housing 11. For magnetic field sensors which are capable of detecting only the strength of the magnetic field but not its polarity, two sensors must be provided per period of the periodic permanent magnetic field. In the case of hall sensors which are also capable of measuring the polarity of the magnetic field, it is sufficient to provide one sensor per period since it is possible to determine based on the direction of the field (polarity) whether the first or second magnet of the respective magnetic period is located in front of the respective sensor (it is a requirement that the magnets in the armature are always mounted in the same manner as regards their direction, so that for example the last magnet always is mounted to the inner side of the armature with its north pole). The distance of these hall sensors from each other then amounts always exactly a length of a period of the periodic permanent magnetic field of the armature.

The following table shows the magnetic fields detected by the hall sensors H₁ to H₈, depending on the number of pole pitches or magnets which extend out of the end 11a of the stator housing 11. The analog measuring signals of the hall sensors are digitized according to their sign and are marked north (“N”) or south (“S”) in the table. As can be easily seen, it is sufficient to evaluate only the odd hall sensors H₁, H₃, H₅ and H₇ arranged at a mutual distance of one length of a period to determine in which pole pitch the armature is located (see right side of the table). It is a condition that—as it is usually the case for hall sensors—they do not only measure the strength but also the polarity of the magnetic field.

TABLE

| Pole | | | | | | | | | | | | |
|---|---|---|---|---|---|---|---|---|---|---|---|---|
| Split | H1 | H2 | H3 | H4 | H5 | H6 | H7 | H8 | H1 | H3 | H5 | H7 |
| 0 | — | — | — | — | — | — | — | — | — | — | — | — |
| 1 | N | — | — | — | — | — | — | — | N | — | — | — |
| 2 | S | N | — | — | — | — | — | — | S | — | — | — |
| 3 | N | S | N | — | — | — | — | — | N | N | — | — |
| 4 | S | N | S | N | — | — | — | — | S | S | — | — |
| 5 | N | S | N | S | N | — | — | — | N | N | N | — |
| 6 | S | N | S | N | S | N | — | — | S | S | S | — |
| 7 | N | S | N | S | N | S | N | — | N | N | N | N |
| 8 | S | N | S | N | S | N | S | N | S | S | S | S |

If the armature accidentally is arranged at a critical position in which the individual external hall sensors are located centred with respect to the individual magnets and are therefore arranged exactly at the zero-crossing of the magnetic field the previously described evaluation fails because all hall sensor measures no magnetic field. The subsequently with the aid of FIG. 6 described second embodiment of the linear motor according to the invention can easily handle this special case.

The second embodiment of the linear motor according to the invention shown in FIG. 6 differentiates from the first embodiment of the linear motor according to the invention shown in FIG. 1 in that it comprises to rows of external hall sensors arranged in the extension 15 of the stator housing 11. The external hall sensors of the first row are designated H₁₁-H₁₈ and the external hall sensors are designated H₂₁-H₂₈. Within each row the distance d₅ between two hall sensors again is exactly one pole pitch or one half of a length of a period of the periodic permanent magnetic field of the armature. However, the two rows are mutually offset in longitudinal direction by a distance d₆ which, for example, is about one eighth of the length of the period P of the magnetic (corresponding to an angle of 45° or π/4). Thus, it is insured that for each position of the armature at least by the hall sensors of one of the two rows a magnetic field is detected which can be detected. The signals of the two rows of hall sensors are again supplied to the evaluation electronics 17 via a multiplexer 18. For example, the evaluation is performed such that depending on the signal strength, either row of hall sensors H₁₁-H₁₈ or the row of hall sensors H₂₁-H₂₈ is considered. For this purpose, the absolute values of the signals within each row of hall sensors are averaged and the signals of that row having a higher averaged value are considered for the calculation. If the two rows of hall sensors are arranged at an advantageous distance of one quarter of the length of the period of the magnetic field (corresponding to an angle of 90° or π/2) even the quadrant within the period in which stator and armature are located can be determined This has advantages for the further evaluation of the exact position. With respect to the number of hall sensors or magnetic field sensors in general required in each row the same considerations apply as have been described further above in connection with the first embodiment. The entirety of the internal or external hall sensors are part of the position detection system 200. For the absolute position detection of the armature 2 (related to the stator 1) the rear end 11a of the stator housing 11 is taken as a reference location. On the other hand, the reference location of the armature 2 is again the rear end 24a thereof.

In the third embodiment of the linear motor according to the invention shown in FIG. 7 the specific magnetic field at the (rear) end of the armature 2 is used for the position detection for the case that all hall sensors are located in the zero-crossing of the periodic magnetic field. In contrast to the more or less sine-shaped field between the individual magnets there results a protruding magnetic field MF the last permanent magnet 22 in the armature 2. This protruding magnetic field MF spatially extends farther than a normal pole pitch. If the number of hall sensors provided in the extension 15 of the stator housing 11 is one more than the number of pole pitches to be detected detects the described special case is covered. Concretely, the following evaluation is performed by the evaluation electronics 17: If all hall sensor except for one have no measuring signal then, the armature is located in that pole pitch which is one position in front of that hall sensor which measures the (only) signal. To perform this kind of evaluation one hall sensor must be mounted for each pole pitch and in total one more hall sensor must be provided than pole pitches or magnets to be detected. In the third embodiment shown nine external hall sensors H₁-H₉ are present. In general, it also is possible, as already explained further above, to mount hall sensors only at the distance of one length of a period i.e. only the odd hall sensors H₁, H₃, H₅, etc. In the critical case an evaluation of the amplitude of the only signal providing hall sensor must be performed. If its amplitude is comparatively high the armature is located in that pole pitch which is located one position before the said hall sensors. If the amplitude is comparatively low (but nevertheless measurable) then, the armature is located in that pole pitch that is located two positions before the said hall sensor.

Apart from the number of external hall sensors and the specific evaluation of their signals the linear motor shown in FIG. 7 corresponds to that shown in FIG. 1 so that no further explanations are required. The entirety of the internal and external hall sensors are part of the position detection system 300. For the absolute position detection of the armature 2 (relative to the stator 1) again the rear end 11a of the stator housing 11 is taken as a reference location. The reference location of the armature 2 is again rear end 24a thereof.

The above mentioned problem of the critical position of the armature in which all external hall sensors measure no magnetic field can also be solved by slightly moving the armature in axial direction out of the critical position of the armature to an extent that the hall sensors measure sufficiently high magnetic fields and generate corresponding signals. In practice, a movement in the order of magnitude of 5% of a pole pitch may be sufficient. However, it is disadvantageous that a small reference run is necessary which may not be acceptable in some applications.

In the above described embodiments of the linear motor according to the invention the position information is derived from the anyway present permanent magnetic field of the armature which enables a less expensive and therefore relatively cheap detection of the absolute position of the armature.

Principally, the invention can also be embodied such that instead of the external hall sensors an other measuring arrangement is used for the detection of the position of the end of the armature. For example, optical or inductive sensors might detect the end of the armature.

According to a fourth embodiment, shown in FIG. 8, the position of the (rear) end of the armature is axially measured. For this purpose, a contactless measuring distance measuring system 400 is arranged at the end 15a of the tubular extension 15 of the stator housing 11 (and therefore in fixed spatial relationship thereto) which measures the distance between the end 15a of the tubular extension 15 of the stator housing 11 and the mechanical end 24a of the armature 2. The reference location of the stator 1 is the distance measuring system 400 mounted at the end 15a of the extension 15 and is therefore due to the predetermined length of the extension 15 indirectly again the rear end 11a of the stator housing 11 (and thereby of the stator 1). The reference location of the armature 2 is the rear end 24a thereof. The distance measuring system 400 can be based, for example, on laser technology, radar technology, or acoustic measuring technology. Generally, the axial detection of the end position of the armature is rather disadvantageous since the already critical installation length of the linear motor increases.

In FIG. 9, a fifth, particularly advantageous embodiment of the linear motor according to the invention is shown. In this embodiment, the distance of the (rear) end of the armature relative to the stator 1 or the rear end 11a of the stator housing 11 as a reference location is measured by means of a laser distance measuring system 500 arranged laterally close to the armature 2. The radial distance of the laser distance measuring system 500 from the armature 2 is as small as possible and preferably amounts only a few millimeters (for example 4 mm to 40 mm) so that the constructional volume of the linear motor is not increased or at least not substantially increased. The laser distance measuring system comprises a laser light source 501 arranged at the end 11a of the stator housing 11 and a laser light receiver 502 also arranged at the end 11a of the stator housing, as well as a disk-shaped laser light reflector 503 which is mounted at the terminal piece 24 of the rear end of the armature 2. The laser light source 501 directs a laser beam to the laser light reflector 503 which reflects the laser beam back to the laser light receiver 502. Such laser distance measuring systems are known per se so that a more detailed description can be dispensed with. By means of the conventional evaluation methods of such laser distance measuring systems the distance of the end of the armature from the stator can be determined or the position of the armature with respect to the pole pitch can be determined In this embodiment, the reference location of the stator 1 is again given by the end 11a of the stator housing 11, the reference location of the armature 2 is the rear end 24a thereof with the reflecting disk-shaped laser light reflector 503 mounted thereto. In this embodiment of the linear motor, the tubular extension of the stator housing can be omitted, but doesn't have to be omitted necessarily.

For the last two embodiments of the linear motor according to the invention shown in FIG. 8 and FIG. 9, the internal Hall sensors H_{A} and H_{B} are not required provided, that the distance measuring system 400 or 500 is sufficiently precise and of sufficiently high definition. Advantageously, the internal Hall sensors are also present in these embodiments, with the initial absolute position detection being performed by means of the distance measuring system 400 or 500 and all further position detections being performed in a known manner on the basis of the measuring signals generated by the internal Hall sensors. If a less precise distance measuring system 400 or 500 or a distance measuring system 400 or 500 of lower definition is used this measuring system can be used to only determine the period of the magnetic field in which the internal Hall sensors are located. The exact position within the period is then again determined like in the embodiments of FIG. 1 to FIG. 7 by means of the measuring signals of the internal hall sensors.

The invention has been explained with the aid of embodiments of a tubular linear motors in which the coils are arranged in the stator and the armature has a permanent excitement. The the absolute position detection of the armature relative to the stator according to the invention may be similarly used in other constructional forms of linear motors.

1. A linear motor comprising a stator (1) which has a longitudinal axis (16), and an armature (2) which is movable relative to the stator (1) between two end positions in the direction of the longitudinal axis (16), wherein either the stator (1) or the armature (2) has energizable electric coils (12) and the armature (2) or the stator (1) is excited by a permanent magnetic field which is periodic in the direction of the longitudinal axis (16), as well as with a position detection system (100; 200; 300; 400; 500) for detecting the position of the armature (2) relative to the stator (1), characterized in that the position detection system (100; 200; 300; 400; 500) is a contactless operating position detection system which is adapted to generate a signal that corresponds to the distance between a reference location (11a; 15a) on the stator (1) and a reference location (24a) on the armature (2).

2. The linear motor according to claim 1, wherein the stator (1) has the coils (12) and the armature (2) is excited by the permanent magnetic field which is periodic in the direction of the longitudinal axis (16), and wherein the position detection system (100; 200; 300) has internal magnetic field sensors (H_{A}; H_{B}) arranged within the stator (1) and external magnetic field sensors (H₁-H₈; H₁₁-H₂₈; H₁-H₉) arranged external to the stator in a fixed spatial relation to the stator (1), which internal and external magnetic field sensors are adapted for the detection of the permanent magnetic field of the armature (2) at the location of the respective magnetic field sensor and for the generation of signals which correspond to the respective detected permanent magnetic field.

3. The linear motor according to claim 2, wherein the internal magnetic field sensors (H_{A}, H_{B}) are arranged offset relative to each other in the direction of the longitudinal axis (16) by one quarter of the length of the period (P) of the armature's (2) periodic permanent magnetic field in a manner such that they are impinged in any position of the armature (2) by the periodic permanent magnetic field thereof.

4. The linear motor according to claim 3, wherein the external magnetic field sensors (H₁-H₈; H₁₁-H₂₈; H₁-H₉) are arranged in the direction of the longitudinal axis (16) along the displacement path of the armature (2) in a manner such that depending on the position of the armature (2) a varying number of the external magnetic field sensors (H₁-H₈; H₁₁-H₂₈; H₁-H₉) are impinged by the periodic magnetic field of the armature (2).

5. The linear motor according to claim 4, wherein the distance between two adjacently and offset to each other arranged external magnetic field sensors (H₁-H₈; H₁₁-H₂₈; H₁-H₉) is half the length of a period (P) of the periodic permanent magnetic field of the armature (2).

6. The linear motor according to claim 4, wherein the external magnetic field sensors (H₁-H₈; H₁₁-H₂₈) are adapted to detect both the strength as well as the polarity of the armature's (2) magnetic field, and wherein the distance between two adjacently and offset to each other arranged external magnetic field sensors (H₁-H₈; H₁₁-H₂₈) is a full length of a period (P) of the periodic permanent magnetic field of the armature (2).

7. The linear motor according to claim 5, wherein the external magnetic field sensor (H₉) which is farthest from the stator (1) is arranged such that it detects the end magnetic field (MF) of the armature (2).

8. The linear motor according to claim 4, wherein the position detection system (200) comprises two rows of external magnetic field sensors (H₁₁-H₁₈; H₂₁-H₂₈), wherein the external magnetic field sensors (H₁₁-H₁₈) of one row are arranged offset in longitudinal direction relative to the external magnetic field sensors (H₂₁-H₂₈) of the other row by a predetermined distance (d₆).

9. The linear motor according to claim 8, wherein the predetermined distance (d₆) between the two rows is at least one eighth, preferably one quarter, of the period (P) of the periodic permanent magnetic field of the armature (2).

10. The linear motor according to claim 2, wherein the linear motor is embodied as a tubular linear motor whose armature (2) is bar-shaped and extends through the stator (1), and wherein the armature (2) is movably arranged within the stator (1) relative thereto.

11. The linear motor according to claim 10, wherein the stator (1) has a tubular extension (15) on one end which encloses the armature (2).

12. The linear motor according to claim 11, wherein the external magnetic field sensors (H₁-H₈; H₁₁-H₂₈; H₁-H₉) are arranged inside the tubular extension (15).

13. The linear motor according to claim 10, wherein the position detection system is embodied as a contactless operating distance measuring system (400) which is arranged on the stator (1) coaxial to the armature (2), and which is capable of generating a signal that corresponds to the distance from an end (24a) of the armature (2) moved out of the stator (1) to the corresponding end of the stator (1) from which the armature (2) is moved out.

14. The linear motor according to claim 13, wherein the position detection system is embodied as a laser distance measuring system (500) which includes a laser light source (501) arranged on the stator (1) and a laser light receiver (502) also arranged on the stator (1), as well as a laser light reflector (503) arranged one end (24a) of the armature (2).

15. The linear motor according to claim 14, wherein the radial distance of the laser distance measuring system (500) from the longitudinal axis is in the range of 4 mm to 40 mm.
